(19) United States
(12) Patent Application Publication
(10) Pub. No.: US 2018/0095019 A1
(43) Pub. Date: Apr. 5, 2018

(54) APPARATUS, SYSTEM AND METHOD FOR PERFORMING BI-AXIAL FORCE TESTING

(71) Applicant: UNIVERSITY OF NEW HAMPSHIRE, Durham, NH (US)

(72) Inventors: Yaning LI, Durham, NH (US); Yunyao JIANG, Durham, NH (US)

(21) Appl. No.: 15/720,511

(22) Filed: Sep. 29, 2017

Related U.S. Application Data
(60) Provisional application No. 62/402,324, filed on Sep. 30, 2016.

(51) Int. Cl. G01N 3/08

(52) U.S. Cl. CPC G01N 3/08; G01M 5/005; G01N 2203/0262; G01N 2203/0254

(57) ABSTRACT

A bi-axial testing apparatus, system and method may be used with known uni-axial material testing machines to perform biaxial displacement control (e.g., compressive and/or tensile) testing on a specimen. As such, the apparatus, system and method may be capable of providing bi-axial compressive or tensile loads with uni-axial motion and only one actuator. The specimen may be a cubic specimen including, without limitation, 3D printed cellular materials, composite materials, foams, bio-medical materials, and the like. The apparatus generally includes a first or top fixture forming a first re-entrant surface and a second or bottom fixture forming a second re-entrant surface. When the fixtures are mounted, the re-entrant surfaces form a testing space in the center to accommodate a specimen to be tested and the re-entrant surfaces provide testing forces in two axes in response to an actuator providing motion of at least one of the fixtures in one axis.

### CROSS-REFERENCE TO RELATED APPLICATIONS

The present application claims the benefit of U.S. Provisional Patent Application Ser. No. 62/402,324 filed Sep. 30, 2016, which is fully incorporated herein by reference.

### TECHNICAL FIELD

The present disclosure relates to material testing and more particularly, to an apparatus, system and method for performing bi-axial force testing.

### BACKGROUND INFORMATION

Materials may need to be tested to determine mechanical properties in compression and/or in tension. Such materials may include, without limitation, 3D printed cellular materials, composite materials, foams, bio-medical materials, metals, polymers, and the like. For some materials, the strength and mechanical behavior, such as instability, in compression and/or tension may be different when applied along different axes. As such bi-axially testing may be conducted to control displacements of the material bi-axially. Conventional bi-axial compression machines use two actuators to provide compression forces in two axes.

### SUMMARY

Consistent with an embodiment, an apparatus for bi-axial force testing includes a first fixture defining a first orthogonal re-entrant surface and a second fixture defining a second orthogonal re-entrant surface. The first and second fixtures are configured to be assembled together and mounted with one of a plurality of different mounting angles such that the first and second re-entrant surfaces form a testing space for receiving a specimen. Relative movement of the first and second fixtures, in response to a testing force applied to at least one of the first and second fixtures along a single testing axis, provides a different bi-axial displacement ratio with each of the different mounting angles.

Consistent with another embodiment, a system for bi-axial force testing includes an actuator for applying a testing force along a testing force axis, a first fixture mounted to the actuator and defining a first re-entrant surface, and a second fixture mounted opposite the actuator and defining a second re-entrant surface. The first fixture is positioned relative to the second fixture such that the first and second re-entrant surfaces form a testing space for receiving a specimen. The first and second fixtures are mounted such that relative movement of the first and second fixtures, in response to the testing force applied to the first fixture along the testing axis, provides forces along two axes to be applied to the specimen.

Consistent with a further embodiment, an apparatus for bi-axial force testing includes a first fixture including a first set of fixture plates defining a first re-entrant surface and a second fixture including a second set of fixture plates defining a second re-entrant surface. The first set of fixture plates include pairs of mounting holes corresponding to different mounting angles and the second set of fixture plates include pairs of mounting holes corresponding to the different mounting angles. The apparatus also includes a first connector configured to be coupled to the first fixture using one of the pairs of mounting holes through the first set of fixture plates and a second connector configured to be coupled to the second fixture using one of the pairs of mounting holes through the second set of fixture plates. The first and second fixtures are configured to be mounted with one of the plurality of different mounting angles such that the first and second re-entrant surfaces form a testing space for receiving a specimen. Relative movement of the first and second fixtures, in response to a testing force applied to at least one of the first and second fixtures along a testing axis, provides a different bi-axial displacement ratio with each of the different mounting angles.

Consistent with yet another embodiment, a method is provided for bi-axially force testing a material specimen. The method includes: mounting a first fixture to an actuator with a mounting angle, the first fixture defining a first re-entrant surface; mounting a second fixture opposite the actuator with the mounting angle, the second fixture defining a second re-entrant surface; positioning the first fixture and the second fixture such that the first and second re-entrant surfaces form a testing space for receiving a material specimen; positioning a material specimen within the testing space; applying a testing force to the first fixture along a testing axis such that the testing force is applied by the first fixture to the specimen along two axes, wherein the mounting angle determines a bi-axial displacement ratio of the first fixture relative to the second fixture.

### BRIEF DESCRIPTION OF THE DRAWINGS

These and other features and advantages will be better understood by reading the following detailed description, taken together with the drawings wherein:

FIG. 1 is a schematic illustration of an apparatus for performing bi-axial force testing, consistent with embodiments of the present disclosure.

FIGS. 2A-2C are schematic illustrations of three different angular positions of the apparatus shown schematically in FIG. 1 providing three different bi-axial displacement ratios.

FIGS. 3A and 3B are schematic illustrations of an apparatus for performing bi-axial force testing with different mounting angles, consistent with other embodiments of the present disclosure.

FIG. 4A is a perspective view of an embodiment of a top fixture of an apparatus for performing bi-axial force testing.

FIG. 4B is a front view of the top fixture shown in FIG. 4A.

FIG. 4C is a side view of the top fixture shown in FIG. 4A.

FIG. 4D is a top view of the top fixture shown in FIG. 4A.

FIG. 5A is a perspective view of an embodiment of a bottom fixture of an apparatus for performing bi-axial force testing.

FIG. 5B is a front view of the bottom fixture shown in FIG. 5A.

FIG. 5C is a side view of the bottom fixture shown in FIG. 5A.

FIG. 5D is a top view of the bottom fixture shown in FIG. 5A.

FIG. 6A is a perspective view of the top and bottom fixtures of FIGS. 4A and 5A assembled as an apparatus for performing bi-axial force testing.

FIG. 6B is a front view of the assembled apparatus for performing bi-axial force testing shown in FIG. 6A.

FIG. 6C is a side view of the assembled apparatus for performing bi-axial force testing shown in FIG. 6A.

FIG. 6D is a top view of the assembled apparatus for performing bi-axial force testing shown in FIG. 6A.

FIG. 7A is a perspective view of the assembled apparatus for performing bi-axial force testing shown with a different mounting angle.

FIG. 7B is a front view of the assembled apparatus shown in FIG. 7A.

FIG. 7C is a side view of the assembled apparatus shown in FIG. 7A.

FIG. 7D is a top view of the assembled apparatus shown in FIG. 7A.

FIGS. 8A-8D are perspective, front, side and top views of another embodiment of the top fixture of an apparatus for performing bi-axial force testing.

FIGS. 9A-9D are perspective, front, side and top views of another embodiment of the bottom fixture of an apparatus for performing bi-axial force testing.

FIGS. 10A and 10B are side and perspective views, respectively, showing the top and bottom fixtures in FIGS. 8A and 9A assembled and mounted in a force testing machine.

FIG. 11A is a perspective view of a further embodiment of a top fixture of an apparatus for performing bi-axial force testing.

FIG. 11B is a front view of the top fixture shown in FIG. 11A.

FIG. 11C is a side view of the top fixture shown in FIG. 11A.

FIG. 11D is a top view of the top fixture shown in FIG. 11A.

FIG. 12A is a perspective view of a further embodiment of a bottom fixture of an apparatus for performing bi-axial force testing.

FIG. 12B is a front view of the bottom fixture shown in FIG. 12A.

FIG. 12C is a side view of the bottom fixture shown in FIG. 12A.

FIG. 12D is a top view of the bottom fixture shown in FIG. 12A.

FIG. 13 is a side view of the top fixture shown in FIG. 11A illustrating the bi-axial compressive displacements associated with the mounting holes.

FIG. 14 is a side view of the bottom fixture shown in FIG. 12A illustrating the bi-axial compressive displacements associated with the mounting holes.

FIGS. 15A and 15B are side and perspective views, respectively, showing the embodiment of the top and bottom fixtures in FIGS. 13 and 14 assembled and mounted in a force testing machine with a first mounting angle.

FIGS. 16A and 16B are side and perspective views, respectively, showing the embodiment of the top and bottom fixtures in FIGS. 13 and 14 assembled and mounted in a force testing machine with a second mounting angle.

### DETAILED DESCRIPTION

An apparatus, system and method, consistent with embodiments of the present disclosure, may be used with known uni-axial material testing machines to perform bi-axial displacement control (e.g., compressive and/or tensile) testing on a specimen. As such, the apparatus, system and method may be capable of providing bi-axial compressive or tensile loads with uni-axial motion and only one actuator. The specimen may be a cubic specimen including, without limitation, 3D printed cellular materials, composite materials, foams, bio-medical materials, and the like. Although the example embodiments described herein are used to perform bi-axial compression testing or experiments, the concepts described herein may also be used to perform bi-axial tension testing or experiments.

The apparatus generally includes a first or top fixture forming a first re-entrant surface and a second or bottom fixture forming a second re-entrant surface. When the fixtures are mounted, the re-entrant surfaces form a testing space in the center to accommodate a specimen to be tested. In embodiments of the apparatus, each fixture may include several identical plates with one re-entrant angle forming re-entrant surfaces. One fixture may be fixed, and the other fixture may be connected to a uni-axial actuator. Therefore, by moving the fixture uni-axially, a bi-axial load is applied by the re-entrant surfaces of the fixtures to the specimen. The plates in the top fixture and the bottom fixture may be assembled interdigitatedly to facilitate large deformation of the specimen. The ratio of the applied displacement (and thus the applied force) in two directions can be controlled by varying or changing the mounting angle of the top and bottom fixtures. In this way, a constant bi-axial displacement ratio may be prescribed during the whole uni-axial compression process. This apparatus may be used to perform bi-axial compression experiments on a common uni-axial material testing machine.

As used herein, the term “re-entrant angle” refers to an angle that points inwardly and the term “re-entrant surface” refers to a surface including sections on either side of a re-entrant angle. The term “orthogonal re-entrant surface” refers to a surface with two sections forming a substantially 90° re-entrant angle. As used herein, the term “cubic” refers to three-dimensional and is not limited to a shape that has three equal and perpendicular axes. Although the example embodiments show fixtures with orthogonal re-entrant surfaces, other re-entrant angles and configurations of the re-entrant surfaces are within the scope of the present disclosure. As used herein, the terms “top” and “bottom” are used to identify the fixtures using a common orientation but are not a limitation. In other words, the top fixture and the bottom fixture may be reversed or may be used side-to-side.

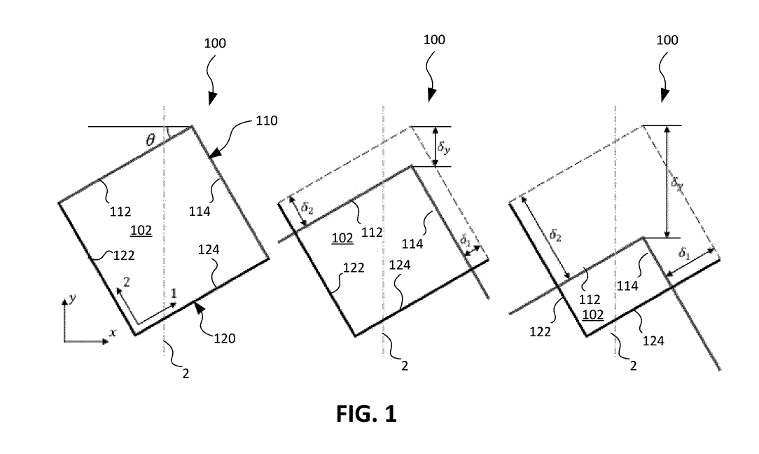

Referring to FIG. 1, the lines 112, 114 represent the re-entrant surface of a top fixture 110 and the lines 122, 124 represent the re-entrant surface of a bottom fixture 120. As will be described in greater detail below, the top and bottom fixtures 110, 120 are assembled such that the re-entrant surfaces form a testing space 102 for receiving a specimen to be tested. The testing space 102 may have a substantially rectangular shape formed by substantially straight sections of the re-entrant surfaces (i.e., represented by lines 112, 114, 122, 124). In the illustrated embodiments, the testing space 102 is initially a square shape, although this is not a limitation of the invention. The fixtures 110, 120 are movable relative to each other to provide a displacement (δ₁, δ₂) of the re-entrant surfaces, thereby applying a force to the specimen within the testing space 102. The fixtures 110, 120 may also be mounted at different angles θ to change the displacement ratio (δ₁/δ₂) in different axes and thus change the biaxial force applied by the fixtures 110, 120 to the specimen in the different axes.

The dot-dash line 2 represents the axis of the applied uni-axial displacement through an actuator (not shown). Two coordinates are used: x-y is the Newtonian frame fixed on the earth; and 1-2 are the coordinates along the two edges of the re-entrant surface. Thus, when the top fixture 110 is moved down with an applied uni-axial displacement δ_{y} in the negative y direction, biaxial displacements (δ₁ and δ₂) will be generated in 1 and 2 directions, respectively. Therefore, the cubic specimen constrained by the two re-entrant surfaces is subjected to in-plane bi-axial compression. If we assume the mounting angle (i.e., the angle between the x direction and the ‘1’ direction of the two coordinate system) of the top and bottom fixture as θ, the bi-axial displacements δ₁ and δ₂, are related to θ and δ_{y} as:

δ₁=δ_{y} sin θ (1)

δ₂=δ_{y} sin θ (2)

Thus, the controlled bi-axial displacement ratio α, defined as α=δ₁/δ₂, is only determined by the mounting angle θ:

α=tan θ 0≤θ≤45° (3)

The mounting angle θ may range from 0° to 90°. When the mounting angle θ=45°, the bi-axial displacement ratio α=1, which is the case of equal biaxial compression. When the mounting angle θ=0° or 90° the bi-axial displacement δ₂=δ_{y}, which is the case of uni-axial plain strain compression. When the mounting angle θ<θ<45°, the bi-axial displacement ratio α<1, and when the mounting angle 45°<θ<90° the bi-axial displacement ratio α>1.

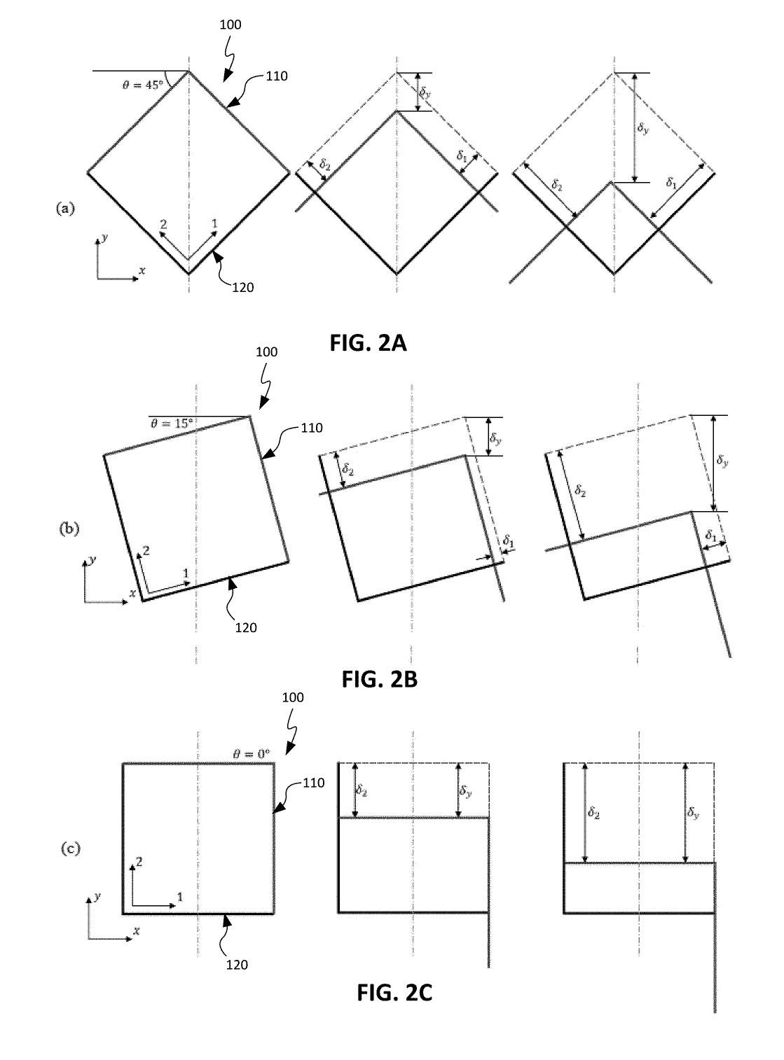

FIGS. 2A-2C schematically show the loading process for three different mounting angles θ and therefore three different bi-axial displacement ratios α. Each of FIGS. 2A-2C shows different bi-axial displacements δ₁ and δ₂ (and thus different bi-axial displacement ratios) with different applied uni-axial displacements δ_{y}. FIG. 2A shows a mounting angle θ=45° and bi-axial displacement ratio α=1. FIG. 2B shows a mounting angle θ=15° and bi-axial displacement ratio α=3.73. FIG. 2C shows a mounting angle θ=0° and bi-axial displacement ratio α=0. Thus, the different mounting angles θ produce different bi-axial displacement ratios and different testing forces along the 1, 2 axes.

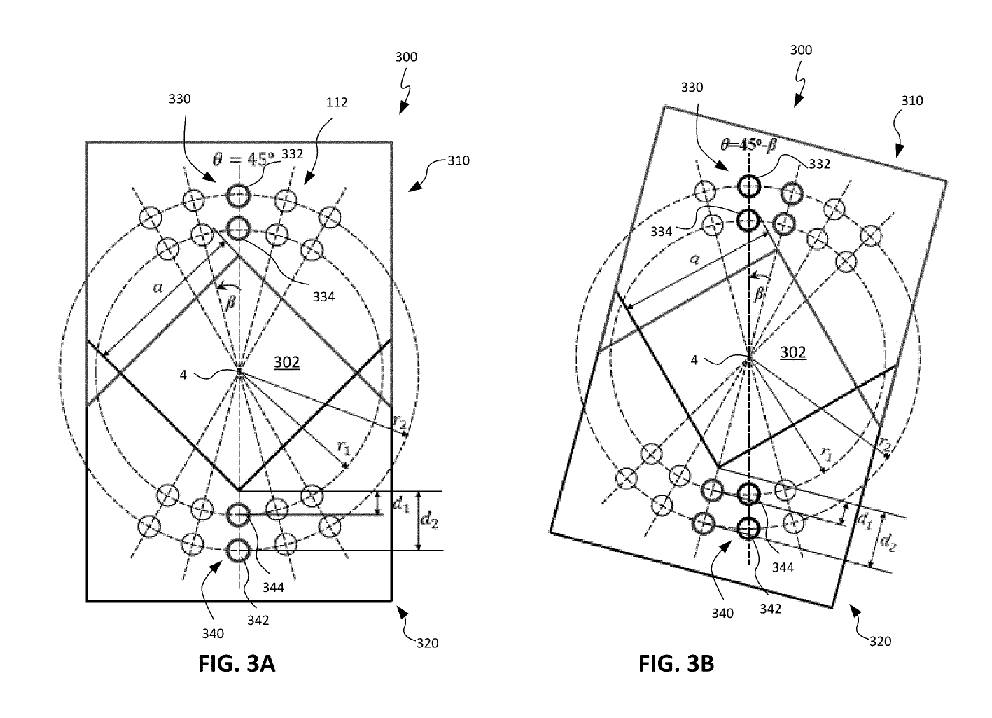

Referring to FIGS. 3A and 3B, an apparatus 300 includes first and second fixtures 310, 320 with different mounting locations or structures 330, 340, such as mounting holes, corresponding to different mounting angles. Although mounting holes are described in the exemplary embodiments, the mounting locations may also include mounting posts, recesses, grooves or any other structures capable of mounting or securing the fixtures 310, 320 at fixed angles.

In the illustrated embodiment, the top fixture 310 and the bottom fixture 320 include two rows of mounting holes 332, 334, 342, 344. The fixtures 310, 320 can be fixed on an actuator (not shown) using bolts and nuts through selected pairs of the mounting holes, which are aligned with a vertical axis. When the top and bottom fixtures 310, 320 are assembled together, the centers of the holes 332, 334, 342, 344 are located on two concentric circles, which have the same center 4 as the square or cubic testing space 302. Thus, the mounting angle θ can be adjusted by rotating the fixtures 310, 320 and then fixing the fixtures 310, 320 through different pairs of holes along the vertical direction and the displacement ratio can be adjusted accordingly.

Quantitatively, the rotation angle of both the top and bottom fixtures 310, 320 about the center of the specimen may be defined as β, whereas β is positive when the fixtures rotate clockwise and negative when the fixtures rotate counter-clockwise, and β is 0 when θ is 45°. The relation between rotation angle β and the mounting angle θ is:

θ=45°−β (4)

Also, the size of the cubic testing area or specimen a may be related to the positions of the centers of the two rows of holes 332, 334, 342, 344 as:

α=2(r₁=d₁)sin 45°=2(r₂−d₂)sin 45° (5)

where r₁ and r₂ are the radii of the inner row of holes and the outer row of holes, respectively; d₁ and d₂ are the closest distances between the vertex of the re-entrant surface(s) to the inner and outer rows of holes on the same fixture, respectively.

According to Eq. (5), the size of specimen can be determined, or if the size of the specimen is known, the positions of two rows of holes (r₁, r₂, d₁ and d₂) can be determined. In other words, the fixtures 310, 320 may be constructed with different sizes and configurations for different sized specimens.

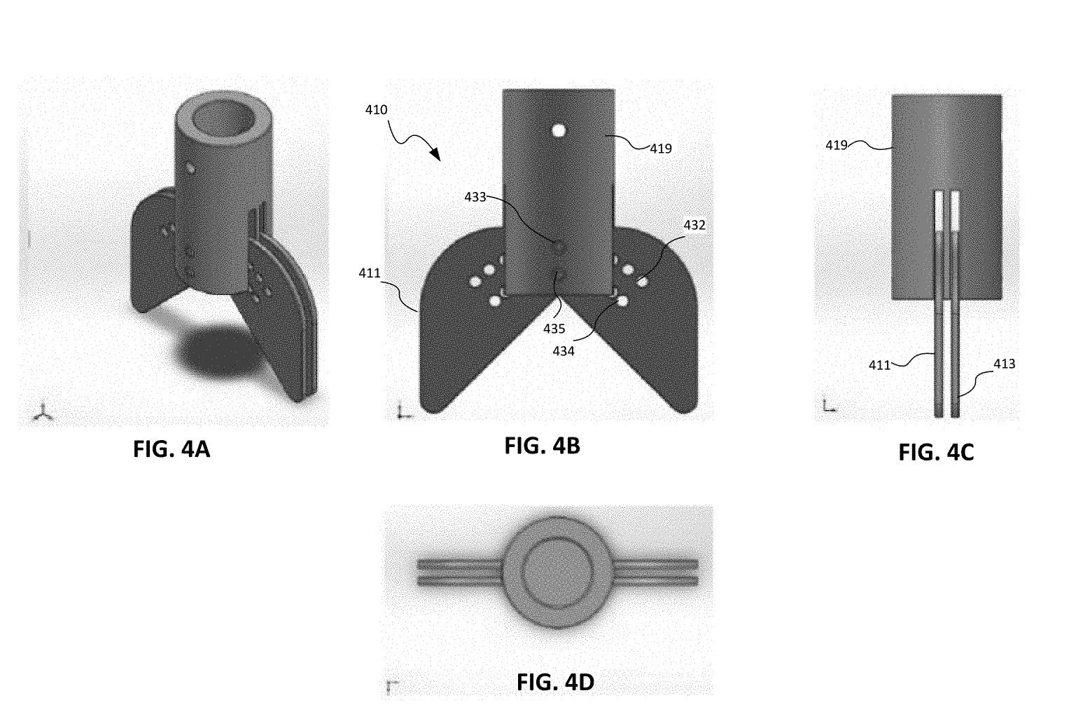

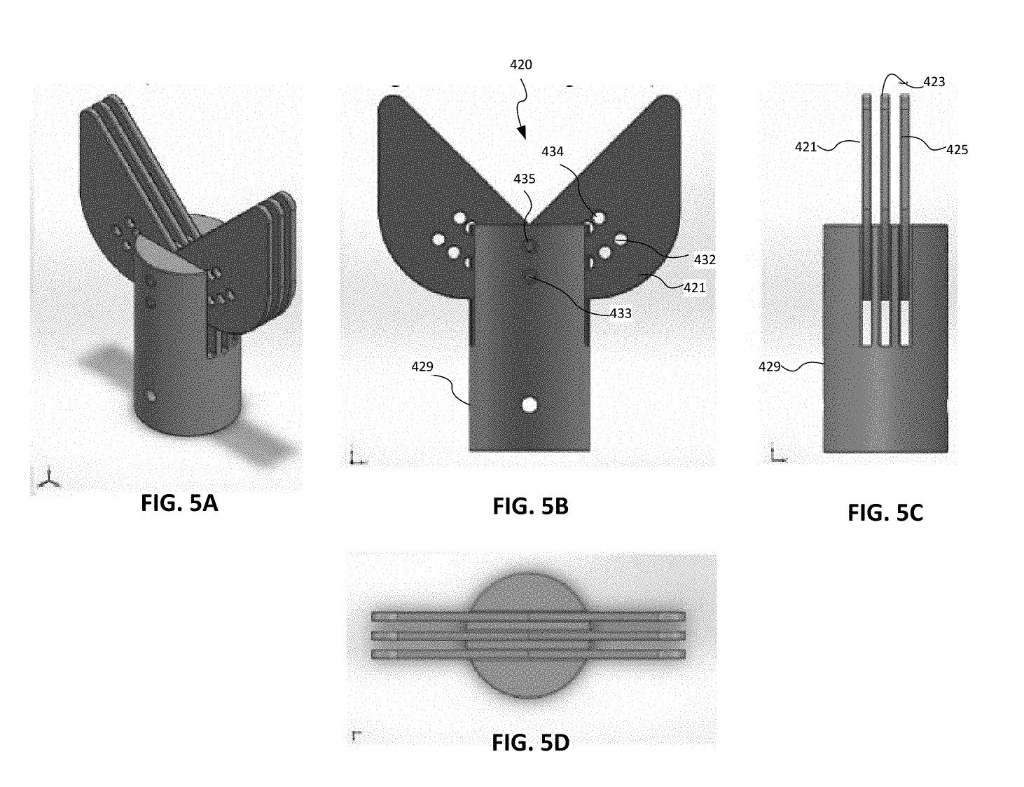

FIGS. 4A-4D, 5A-5D, 6A-6D and 7A-7D show an embodiment of the fixtures 410, 420 and assembled apparatus 400 designed using the theory discussed above. In this embodiment, as shown in FIGS. 4A-4D, the first or top fixture 410 includes a first set of fixture plates 411, 413 including mounting holes 432, 434. The fixture plates 411, 413 are mounted to a connector 419 using two pairs of bolts and nuts 433, 435. In this embodiment, as shown in FIGS. 5A-5D, the second or bottom fixture 420 includes a second set of fixture plates 421, 423, 425 including mounting holes 442, 444. The fixture plates 421, 423, 425 are mounted to a connector 429 using two pairs of bolts and nuts 443, 445. In both fixtures 410, 420, the bolts 433, 435, 443, 445 are used in the mounting holes corresponding to a desired mounting angle θ and bi-axial displacement ratio. In the illustrated embodiment, the connectors 419, 429 are cylindrical; but other shapes and configurations are within the scope of the present disclosure. Also, other types of fasteners may be used to secure the plates to connectors 419, 429. In this embodiment, the plates 411, 413 and the plates 421, 423, 425 form the respective re-entrant surfaces of the respective fixtures 410, 420.

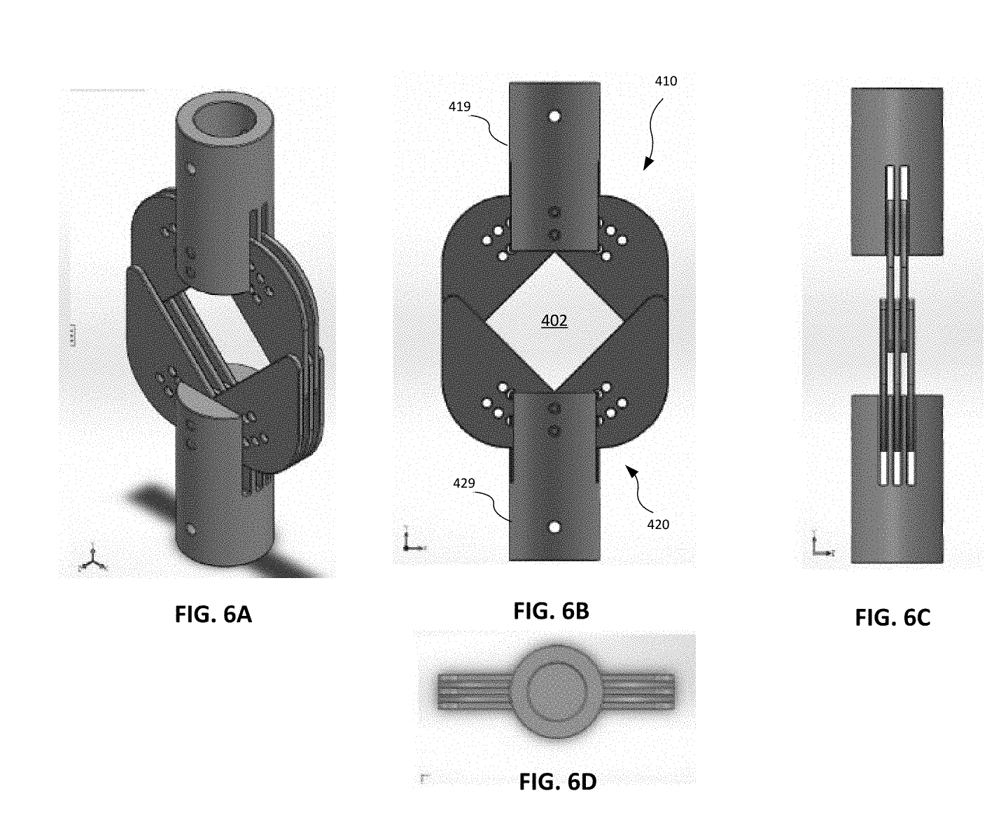

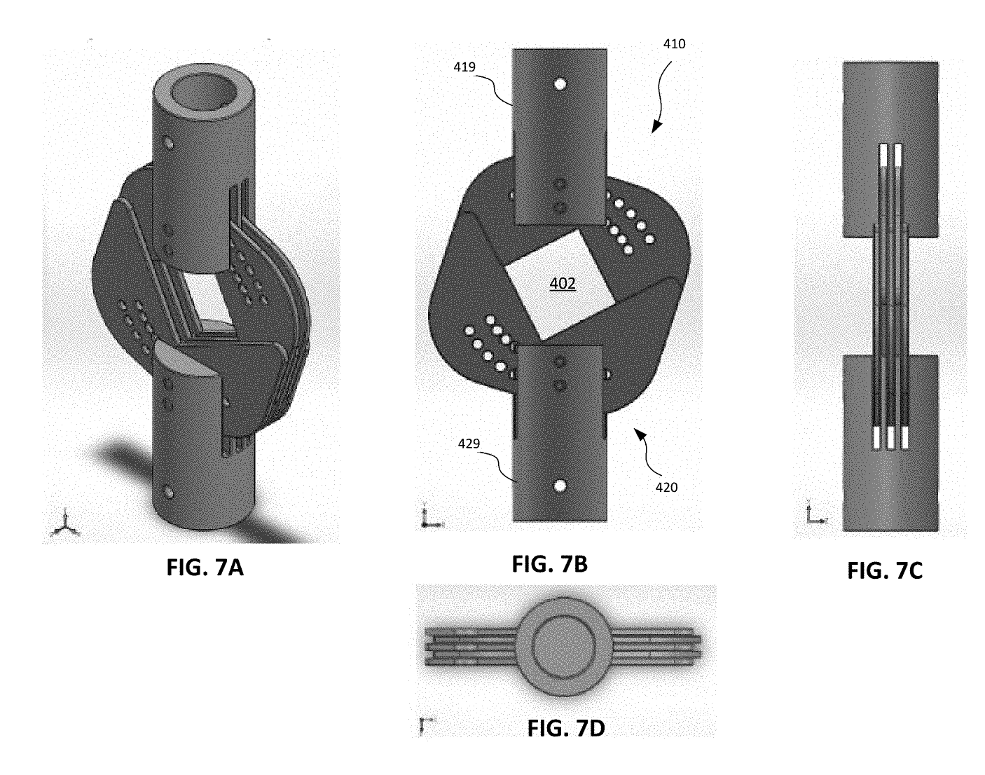

FIGS. 6A-6D show the apparatus 400 with the top and bottom fixtures 410, 420 assembled to form the cubic testing space 402 and mounted with a mounting angle of θ=45°. FIGS. 7A-7D show the apparatus 400 with the top and bottom fixtures 410, 420 assembled to form the cubic testing space 402 and mounted with a mounting angle of θ=30°. The connectors 419, 429 may be mounted to an actuator (not shown) and a support (not shown) opposite the actuator, as described in greater detail below.

To avoid the potential contact between the top re-entrant surface and the bottom re-entrant surface during the movement of the top fixture 410, the plates on the top fixture 410 and the bottom fixture 420 are assembled parallel to each other in an interdigitated manner (see FIGS. 6C and 7C). The number of plates and the distance between the plates on each fixture can change and may be determined by the thickness of the specimen. Although the illustrated embodiment shows two plates 411, 413 on the top fixture 410 and three plates 421, 423, 425 on the bottom fixture, this is not a limitation of the present disclosure.

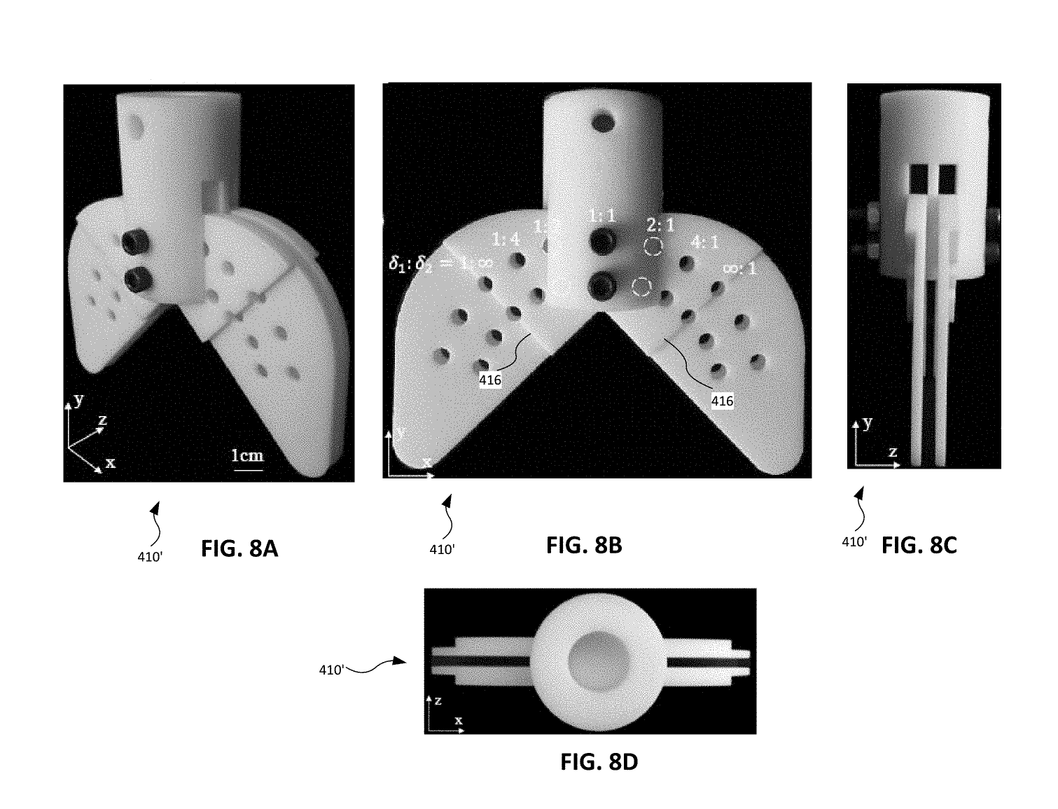

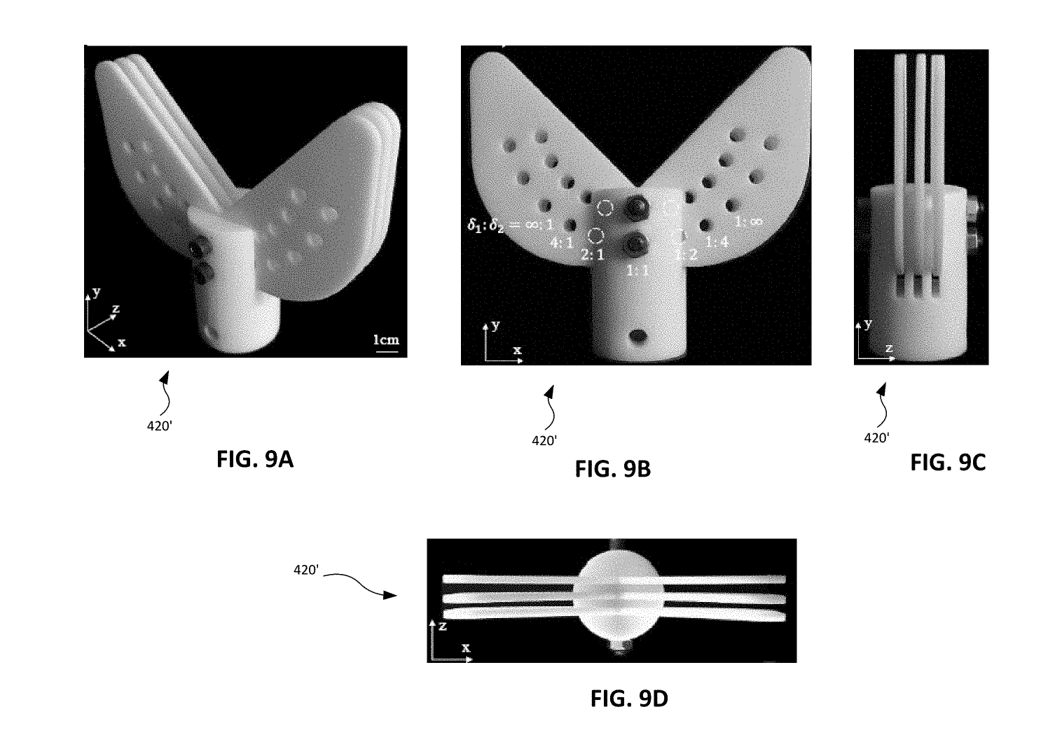

As shown in FIGS. 8A-8D and 9A-9D, another embodiment of the apparatus for bi-axial compression is shown and described. An embodiment of the fixtures was fabricated via additive manufacturing, using a multi-material 3D-printer (Objet Connex260) from a VeroWhite 3D printing material. The fixtures may also be manufactured from metal or other suitable materials.

In this illustrated embodiment, the top fixture 410′ (FIGS. 8A-8D) is composed of two plates and a cylindrical connector and the three parts were assembled through two pairs of bolts and nuts similar to the top fixture 410 described above. In this example embodiment of the top fixture 410′, the top fixture plates include raised edges 416 that will contact the re-entrant surface of the bottom fixture plates to provide a stop limiting the displacement of the top fixture 410′ relative to the bottom fixture 420′. In the illustrated embodiment, the bottom fixture 420′ (FIGS. 9A-9D) is composed of three plates and a cylindrical connector and the four parts are also assembled through two pairs of bolts and nuts.

In this illustrated embodiment, the positions of the mounting holes in the bottom fixture 420′ are designed to match with those in the top fixture 410′ and the positions of the mounting holes on the plates of the fixtures 410′, 420′ are designed to control the ratio of the bi-axial compressive displacement to be a constant for each mounting angle. FIGS. 8B and 9B illustrate the ratio of bi-axial compressive displacement

$$( α = \frac{{δ}_{1}}{{δ}_{2}} , )$$

corresponding to the mounting holes. If the fixture is mounted on a material testing machine through the middle pair of holes (as shown), the ratio of bi-axial compressive displacement (α) is 1:1. The ratio of biaxial compressive displacements (α) for the next pairs of holes will be 2:1, 4:1, and ∞:1 in a clockwise direction, and 1:2, 1:4 and 1:∞ in a counter-clockwise direction.

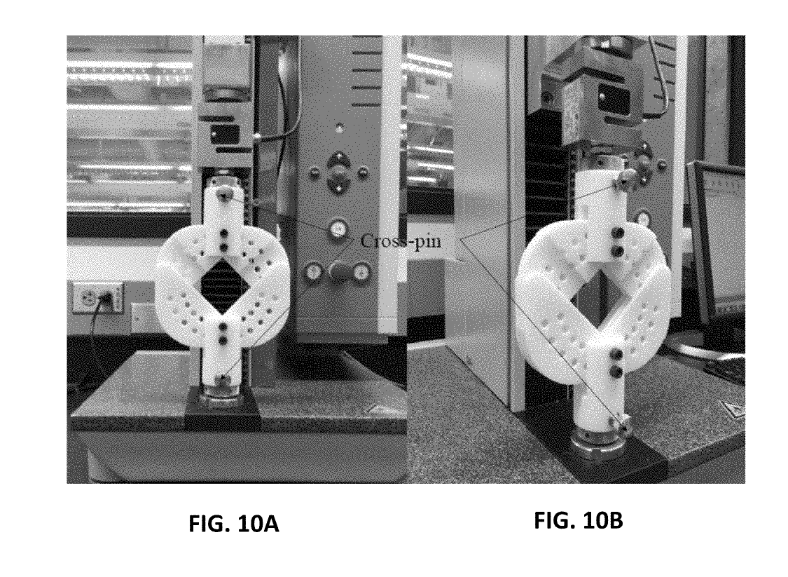

As shown in FIGS. 10A and 10B, both the top and the bottom fixtures 410′, 420′ may be assembled and connected to the column of a material testing machine, such as a Zwick/Roell testing machine, through a cross-pin. The sample or specimen may be placed in the middle testing space for testing.

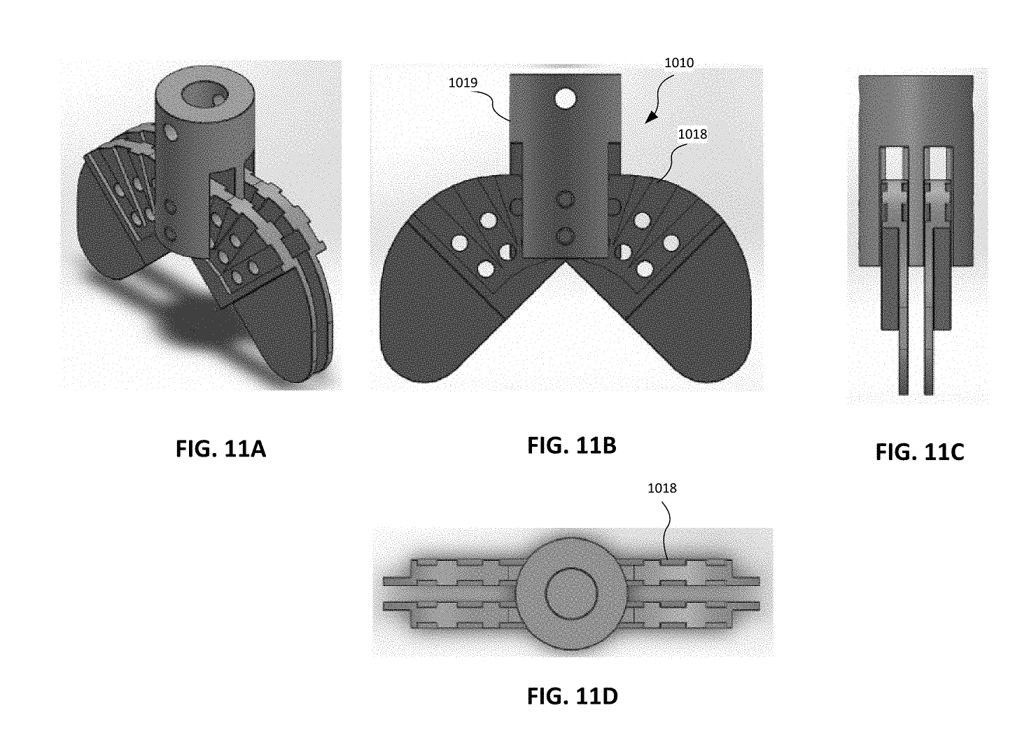

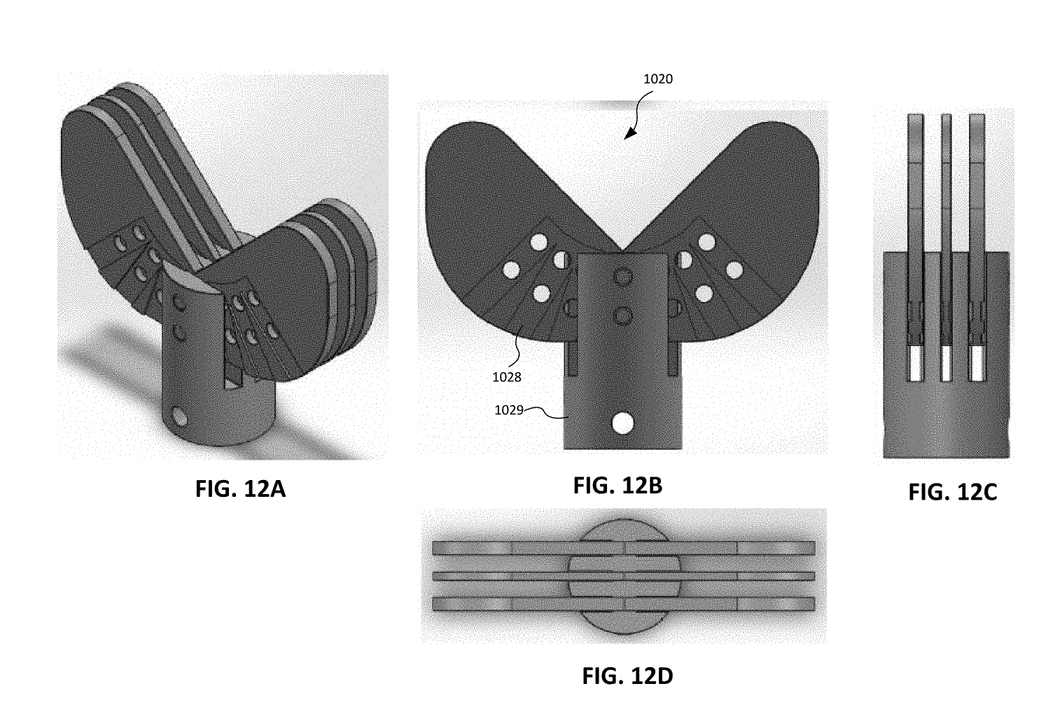

Referring to FIGS. 11A-11D, 12A-12D, 13, 14, 15A-15B, and 16A-16B, another embodiment of the apparatus 1000 is shown and described. In this embodiment, the top fixture 1010 and/or bottom fixture 1020 includes mounting channels 1018, 1028 (e.g., on one or more of the plates). The channels 1018, 1028 allow the column or connector 1019, 1029 and the fixtures 1010, 1020 (e.g., the plates) to interlock with each other to reduce the potential slight rotation of the top and bottom plates on the respective fixture 1010, 1020 with respect to the cylindrical column or connector 1019, 1029. The channels also make it easier and more accurate to change the mounting angle to achieve different bi-axial displacement ratios.

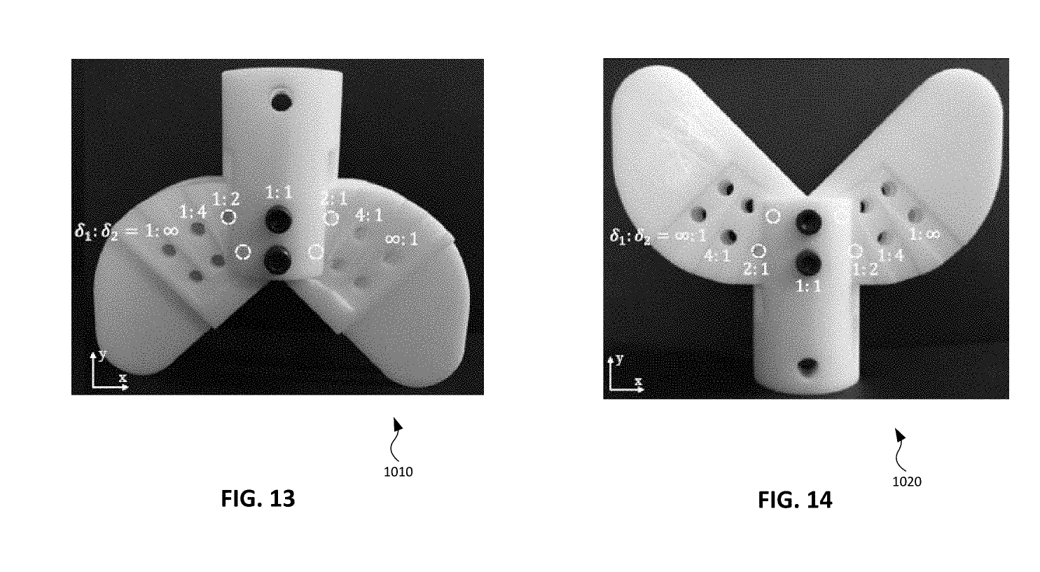

Similar to the embodiment described above, the positions of the mounting holes on the plates are designed to control the ratio of the bi-axial compressive displacement to be a constant for each mounting angle, as shown in FIGS. 13 and 14. If the fixture is mounted on a material testing machine through the middle pair of holes, the ratio of bi-axial compressive displacement

$$( α = \frac{{δ}_{1}}{{δ}_{2}} )$$

is 1:1. The ratio of biaxial compressive displacements (a) for the next pairs of holes will be 2:1, 4:1, and ∞:1 in a clockwise direction, and 1:2, 1:4 and 1:∞ in a counter-clockwise direction. Slots or channels are grooved on the plates for each pair of mounting holes to help precisely position the plates. The channels may thus improve the accuracy of the selected ratio of compressive displacement.

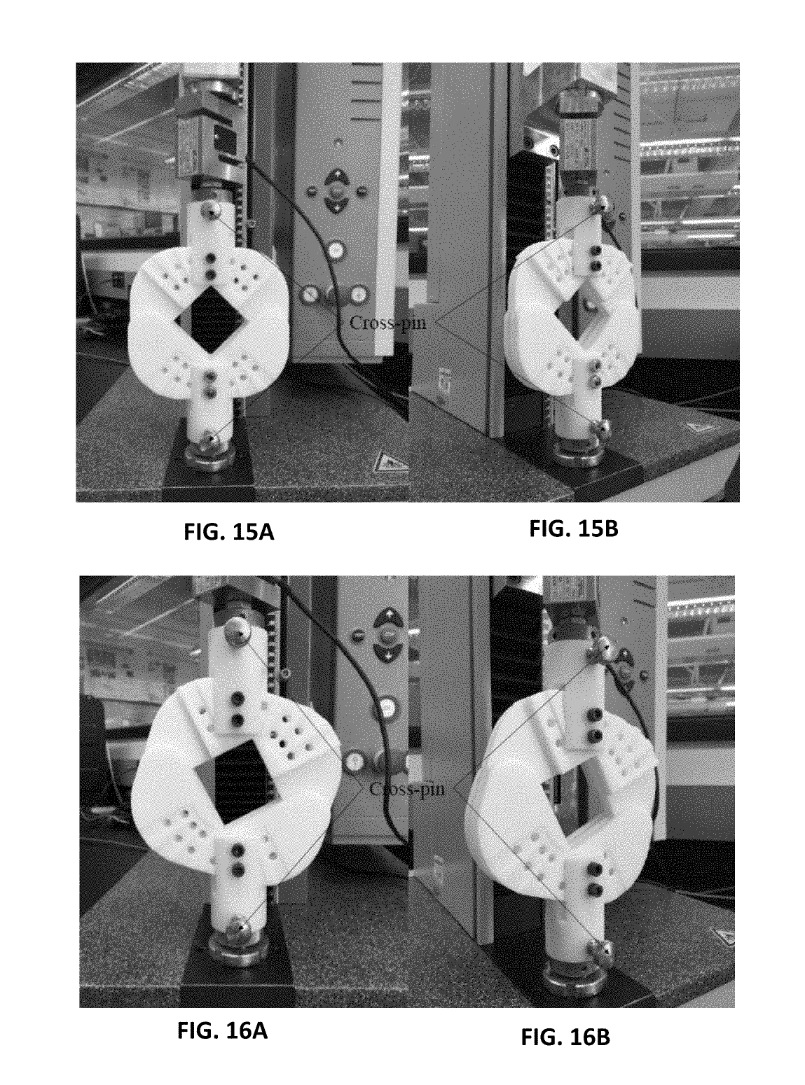

FIGS. 15A, 15B, 16A and 16B show this embodiment of the top and the bottom fixtures 1010, 1020 connected to the column of a material testing machine, such as a Zwick/Roell testing machine, through a cross-pin. FIGS. 15A and 15B show the apparatus mounted with a mounting angle to provide a bi-axial displacement ratio δ₁:δ₂ of 1:1 and FIGS. 16A and 16B show the apparatus mounted with a mounting angle to provide a bi-axial displacement ratio δ₁:δ₂ of 1:2.

Accordingly, an apparatus, system and method, consistent with embodiments of the present disclosure, may be used to provide bi-axial force testing on a specimen using uni-axial motion provided by a uni-axial actuator (e.g., in a uni-axial force testing machine). The bi-axial forces may be easily adjusted by changing the mounting angle, which changes the bi-axial displacement ratio.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An apparatus for bi-axial force testing, comprising:
a first fixture defining a first orthogonal re-entrant surface;
a second fixture defining a second orthogonal re-entrant surface; and
wherein the first and second fixtures are configured to be assembled together and mounted with one of a plurality of different mounting angles such that the first and second re-entrant surfaces form a testing space for receiving a specimen and such that relative movement of the first and second fixtures, in response to a testing force applied to at least one of the first and second fixtures along a single testing axis, provides a different bi-axial displacement ratio with each of the different mounting angles.

2. The apparatus of claim 1 further comprising first and second connectors configured to be secured to the first and second fixtures, respectively, and to a force applying actuator for applying the force along the single force testing axis.

3. The apparatus of claim 1 wherein the first and second fixtures are configured to be secured within a force testing machine that applies the testing force along the single force testing axis.

4. The apparatus of claim 1 wherein the first and second fixtures each include at least one plate.

5. The apparatus of claim 1 wherein the first and second fixtures each include a plurality of plates configured to be assembled interdigitatedly.

6. The apparatus of claim 1 wherein the first and second fixtures include mounting locations corresponding to the different mounting angles and for mounting the first and second fixtures with corresponding ones of the plurality of different mounting angles.

7. The apparatus of claim 6 wherein the mounting locations include pairs of mounting holes corresponding to the different mounting angles.

8. The apparatus of claim 6 wherein the first and second fixtures each include at least one plate, and wherein the plate includes channels corresponding to the mounting locations.

9. The apparatus of claim 6 wherein, when the top and bottom fixtures are assembled to form the testing space, the mounting locations on the first and second fixtures form a circle having a center coinciding with a center of the testing space.

10. The apparatus of claim 7 wherein, when the first and second fixtures are assembled to form the testing space, the mounting holes on the first and second fixtures form concentric circles having a center coinciding with a center of the testing space.

11. A system for bi-axial force testing, comprising:
an actuator for applying a testing force along a testing force axis;
a first fixture mounted to the actuator, the first fixture defining a first re-entrant surface;
a second fixture mounted opposite the actuator, the second fixture defining a second re-entrant surface;
wherein the first fixture is positioned relative to the second fixture such that the first and second re-entrant surfaces form a testing space for receiving a specimen; and
wherein the first and second fixtures are mounted such that relative movement of the first and second fixtures, in response to the testing force applied to the first fixture along the testing axis, provides forces along two axes to be applied to the specimen.

12. The system of claim 11 wherein the actuator applies a compressive force for displacing the first fixture toward the second fixture.

13. The system of claim 11 wherein the first and second fixtures are mounted with one of a plurality of different mounting angles, and wherein a different bi-axial displacement ratio is provided with each of the different mounting angles.

14. An apparatus for bi-axial force testing, comprising:
a first fixture including a first set of fixture plates defining a first re-entrant surface, and wherein the first set of fixture plates include pairs of mounting holes corresponding to different mounting angles;
a first connector configured to be coupled to the first fixture using one of the pairs of mounting holes through the first set of fixture plates;
a second fixture including a second set of fixture plates defining a second re-entrant surface, and wherein the second set of fixture plates include pairs of mounting holes corresponding to the different mounting angles;
a second connector configured to be coupled to the second fixture using one of the pairs of mounting holes through the second set of fixture plates; and
wherein the first and second fixtures are configured to be mounted with one of the plurality of different mounting angles such that the first and second re-entrant surfaces form a testing space for receiving a specimen and such that relative movement of the first and second fixtures, in response to a testing force applied to at least one of the first and second fixtures along a testing axis, provides a different bi-axial displacement ratio with each of the different mounting angles.

15. The apparatus of claim 14 wherein the bi-axial displacement ratios include 1:∞, 1:4, 1:2, 1:1, 2:1, 4:1, and ∞:1.

16. The apparatus of claim 14 wherein the first and second sets of plates define channels corresponding to the mounting holes and configured to engage the first and second connectors.

17. A method of bi-axially force testing a material specimen, the method comprising:
mounting a first fixture to an actuator with a mounting angle, the first fixture defining a first re-entrant surface;
mounting a second fixture opposite the actuator with the mounting angle, the second fixture defining a second re-entrant surface;
positioning the first fixture and the second fixture such that the first and second re-entrant surfaces form a testing space for receiving a material specimen;
positioning a material specimen within the testing space;
applying a testing force to the first fixture along a testing axis such that the testing force is applied by the first fixture to the specimen along two axes, wherein the mounting angle determines a bi-axial displacement ratio of the first fixture relative to the second fixture.

18. The method of claim 17 further comprising mounting the first fixture and the second fixture with a different mounting angle and applying a testing force to the first fixture along the single testing axis to produce a different bi-axial displacement ratio.

19. The method of claim 17 wherein mounting the first fixture and the second fixture includes selecting a pair of mounting holes corresponding to a selected bi-axial displacement ratio and mounting the first and second fixtures to connectors through the selected pairs of mounting holes.

20. The method of claim 17 wherein the first and second fixtures includes first and second sets of plates, and wherein positioning the first fixture and the second fixture includes interdigitating the plates.
